(19) United States
(12) Patent Application Publication
(10) Pub. No.: US 2020/0050688 A1
(43) Pub. Date: Feb. 13, 2020

(54) BLOCK-CHAIN BASED DISTRIBUTED DATA STORAGE APPARATUS AND METHOD FOR STORING LARGE DATA

(71) Applicant: YMAX Co., Ltd, Seoul (KR)

(72) Inventor: Gi Hong Yang, lncheon (KR)

(21) Appl. No.: 16/145,313

(22) Filed: Sep. 28, 2018

(30) Foreign Application Priority Data
Aug. 8, 2018 (KR) 10-2018-0092205

(51) Int. Cl. G06F 17/30; G06F 21/60; G06Q 20/06

(52) U.S. Cl. CPC G06F 17/30194; G06F 17/30283; H04L 63/06; G06Q 20/065; G06F 21/602

(57) ABSTRACT

The present invention relates to a block-chain-based distributed data storage device and method, and more particularly, to a block-chain-based distributed data storage device and method, capable of maintaining stability and security of the block-chain technique by storing dta based on the block-chain technique, capable of efficiently storing a large amount of data while storing data by using the block-chain technique, capable of maximizing efficiency and stability of data storage by collecting and analyzing a status of a node storage in which data is stored for efficient data storage, capable of maximizing data storage efficiency for a longer period of use by learning a data storage pattern through an artificial intelligence, and capable of automatically performing compensation by analyzing a contribution level of data storage to efficiently perform data input/output without external intervention.

### CROSS-REFERENCE TO RELATED APPLICATION

This application claims priority to and the benefit of Korean Patent Application No. 10-2018-0092205 filed in the Korean Intellectual Property Office on Aug. 8, 2018, the entire contents of which are incorporated herein by reference.

### BACKGROUND OF THE INVENTION

### (a) Field of the Invention

The present invention relates to a distributed data storage apparatus and method capable of storing a large amount of data based on a block chain. More particularly, the present invention relates to a data storage device capable of storing large amount of data based on a technique of a block chain which is one of distributed databases. The block-chain technique, which serves to distribute and store same data to all users' computers, is a distributed database technique having excellent stability capable of preventing forgery and alteration of data and capable of restoration to normal data from distributed and stored data of other node even when missing or errors occur in some storage device. However, the block chain technique has a disadvantage in that it is inefficient to store a large amount of data as the same data is distributed and stored in various storage devices. The present invention relates to a block-chain-based distributed data storage apparatus and method capable of efficiently storing a large amount of data while maintaining the security and stability of the block-chain technique.

### (b) Description of the Related Art

Recently, as the infrastructure related to communication has expanded dramatically, the Internet has developed into a high-speed Internet environment beyond popularization. In addition, as the Internet speed increases, the size of data to be transmitted is also increasing. As the Internet speed increases and the Internet environment becomes more widespread, a method of configuring a distributed database type storage connected to a network such as the Internet and using it to store data as if data is stored in a PC through the Internet is gradually becoming commonplace instead of storing data in a specific storage device such as a PC.

Data can be inputted into or outputted from any place by storing the data in a distributed DB-type storage when an Internet connection is available instead of providing a storage device in a specific space, thereby overcoming conventional space constraints. In addition, it is very easy to use because the data may be inputted or outputted anytime and anywhere.

However, since the distributed DB-based storage method using the Internet is a method of providing a large-capacity server connected to the network and storing data therein, the data may be lost when the large-capacity server falls or causes errors. In addition, even if data to be stored is encrypted, the Internet open to the public is used, and thus security is poor due to leakage of data caused by hacking etc. during data input and output.

Recently, research on the block-chain technique is being carried out in earnest as a way to solve the problem. The block-chain technique is a technique based on a pear to pear (P2P) network as distributed database techniques. The block-chain technique is a technique of physically distributing data to be stored to all nodes (users) connected to the network and storing it therein. Since same data is stored in all the nodes, even if the data stored in one node is lost, the data is stored in a stable manner, thereby obtaining excellent storage stability. In addition, even if the data stored in one node is forged or falsified, it can be modified into normal data by comparing with the data stored in another node, so that forgery and falsification of data is fundamentally impossible.

However, the block chain technique is very inefficient in storing a large amount of data as same data is distributed to all nodes.

To solve such a problem, Korean Patent Application Publication No. 10-2018-0054497 discloses an electronic device for authenticating a large amount of data and a plurality of merging and division data and a control method thereof, capable of quickly and efficiently performing authentication of the large data by extracting a necessary data area and authenticating the large data through the data area in the authentication of the large data. This is a technique related to authentication of a large amount of data, but does not store the large data by using the block-chain method, which is poor in stability and security of data. Further, a risk of data loss is large as original data is stored in one storage space.

In addition, Korean Patent Registration No. 10-1720268 discloses a cloud database construction for protecting patient information and a reading method therefor. The database construction and the reading method of No. 10-1720268 enhances security and stability by storing only patient information in a block-chain manner, but has a conventional problem in that medical information except the patient information is stored in a conventional database manner.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention, which is contrived to solve the aforementioned problems, provides a block-chain-based distributed data storage device and method, capable of maintaining stability and security of the block-chain technique by storing data based on the block-chain technique, capable of efficiently storing a large amount of data while storing data by using the block-chain technique, capable of maximizing efficiency and stability of data storage by collecting and analyzing a status of a node storage in which data is stored for efficient data storage, capable of maximizing data storage efficiency for a longer period of use by learning a data storage pattern through an artificial intelligence, and capable of automatically performing compensation by analyzing a contribution level of data storage to efficiently perform data input/output without external intervention.

To solve the above problems, an aspect of the present invention features a block-chain-based distributed data storage device for storing a large amount of data, including: a distribution module configured to include two or more node storages connected with each other through a network including Internet and Ethernet and each including a local storage that is a storage space for data to be stored in the distributed data storage device; a data input/output module configured to input and store data in the node storages included in the distribution module and to read data stored in the node storages therefrom and output it; an encryption/decryption module configured to encrypt or decrypt data when the data is inputted into or outputted from the node storages included in the distribution module; and a module configured to analyze a status of the node storages included in the distribution module inputted or outputted through the data input/output module, a data analysis and management module configured to analyze a status of the node storages included in the distribution module based on data inputted/outputted through the data input/output module and efficiently managing storage of data in the distribution module by using the analyzed status, wherein all the node storages included in the distribution module stores and updates block data among data inputted or outputted whenever the data is inputted or outputted through the data input/output module, and the block data includes positions at which the data is stored in the node storages included in the distribution module, encryption/decryption data necessary for data encryption/decryption in the encryption/decryption module, and authority data for determining authority of data input/output.

The data analysis and management module may input a copy of same data as data inputted through the data input/output module, into the two or more node storages included in the distribution module.

The data analysis and management module may collect a number of node storages that are normally operated among the node storages in which the copy of the same data is stored every predetermined time.

The data analysis and management module may replicate the copy to another node storage included in the distribution module when the number of normally operating node storage becomes smaller than a predetermined number.

The data analysis and management module may control a number of the node storages that maintains the copy of the same data after learning information related to normally operating node storages collected at the predetermined time by artificial intelligence, and then learning a pattern of a number of the normally operating node storages.

The distribution module may further include at least one distribution server connected with each node storage, and the distribution server may provide a configuration for driving the block-chain-based distributed data storage device together with the data input/output module, the encryption/decryption module, and the data analysis and management module.

The distributed data storage device may further include a compensation module configured to calculate a contribution level including a data input/output amount of each node storage and a data storage time, after the data analysis and management module collects a status of data inputted/outputted into/from each node storage in the distribution module.

The compensation module may compensate an owner of each node storage with crypto currency according to the calculated contribution level.

To solve the above problems, an aspect of the present invention features a block-chain-based distributed data storage method for storing a large amount of data, including: a data input/output operation of inputting/outputting data through a data input/output module which inputs and store data in a distribution module configured to include two or more node storages connected with each other through a network including Internet and Ethernet and each including a local storage and to read data stored in the node storage therefrom and output it; a data encryption/decryption operation of encrypting or decrypting data through an encryption/decryption module when the data is inputted into or outputted from the node storages included in the distribution module; and a data analysis and management operation of analyzing a status of the node storages included in the distribution module through the data analysis and management module based on data inputted/outputted through the data input/output module and efficiently managing storage of data in the distribution module by using the analyzed status, wherein the distributed data storage method further comprises storing and updating block data among data inputted or outputted whenever the data is inputted or outputted in the data input/output operation, and the block data includes positions at which the data is stored in the node storages included in the distribution module, encryption/decryption data necessary for encryption/decryption in the encryption/decryption module, and authority data for determining authority of data input/output.

A copy of same data as data inputted through the data input/output module may be inputted into the two or more node storages included in the distribution module, in the data input/output operation.

The distributed data storage method may further include collecting a number of node storages that are normally operated among the node storages in which the copy of the same data is stored every predetermined time through the data analysis and management module, in the data analysis and management operation.

The distributed data storage method may further include replicating the copy to another node storage included in the distribution module when the number of normally operating node storage becomes smaller than a predetermined number through the data analysis and management module, in the data analysis and management operation.

The distributed data storage method may further include controlling a number of the node storages that maintains the copy of the same data after learning information related to normally operating node storages collected at the predetermined time by artificial intelligence, and then learning a pattern of a number of the normally operating node storages through the data analysis and management module, in the data analysis and management operation.

The distributed data storage method may further include a contribution level calculation operation of calculating a contribution level including a data input/output amount of each node storage and a data storage time through a compensation module based on a status of data inputted/outputted into/from each node storage in the distribution module, collected by the data analysis and management module, in the data analysis and management operation.

The compensation module may compensate an owner of each node storage with crypto currency according to the calculated contribution level, in the contribution level calculation operation.

According to the exemplary embodiment of the present invention, it is possible to maintain stability and security of the block-chain technique when data is stored.

It is also possible to efficiently store a large amount of data while maintaining the stability and security, which is an advantage of the block-chain technique.

In addition, it is possible to maximize data storage efficiency by reflecting a status of a node storage in which data is stored in real time, learning a storage pattern of the node storage through an artificial intelligence, and controlling a number of the node storage in which data is stored.

Finally, since a contribution level of the node storage is grasped in real time by grasping a status of data input/output and then compensation therefor is automatically performed, the data input/output and storage are efficiently performed without external intervention.

### BRIEF DESCRIPTION OF THE DRAWINGS

FIG. 1 illustrates a schematic block diagram of a block-chain-based distributed data storage device for storing a large amount of data according to an exemplary embodiment of the present invention.

FIG. 2 illustrates a process of storing data in each node storage in the block-chain-based distributed data storage device according to an exemplary embodiment of the present invention.

FIG. 3 illustrates a process of controlling data stored in each node storage according to a status of the node storages in the block-chain-based distributed data storage device.

FIG. 4 is a flowchart illustrating a block-chain-based distributed data storage method for storing a large amount of data according to an exemplary embodiment of the present invention.

### DETAILED DESCRIPTION OF THE EMBODIMENTS

Hereinafter, a block-chain-based distributed data storage device and method according to an exemplary embodiment of the present invention will be described in detail with reference to the accompanying drawings.

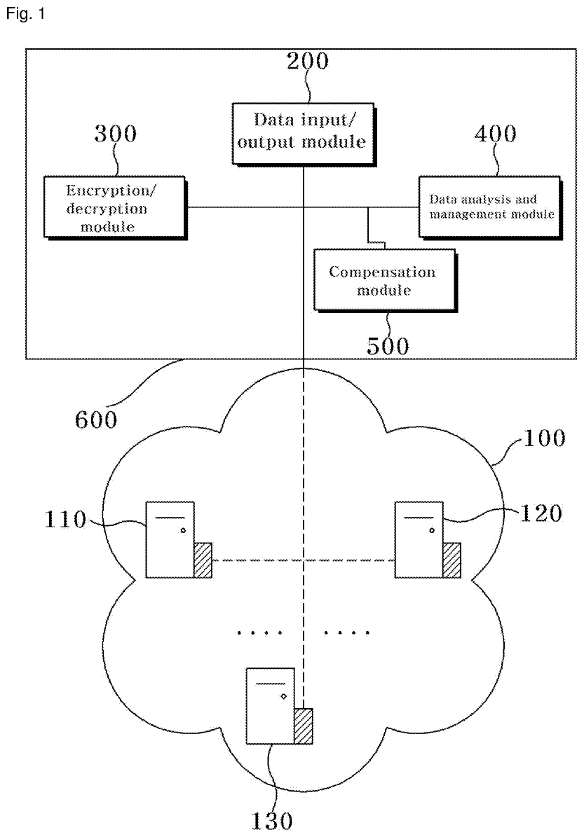

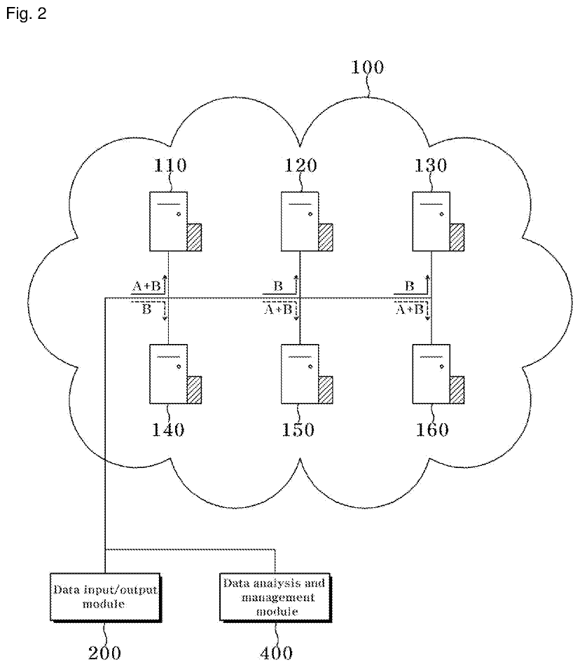

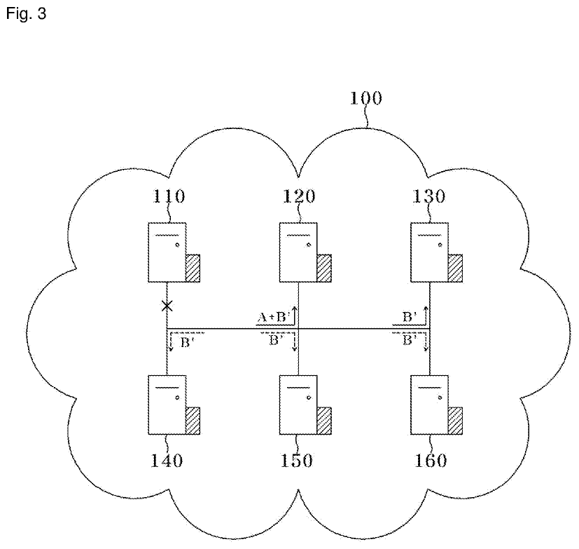

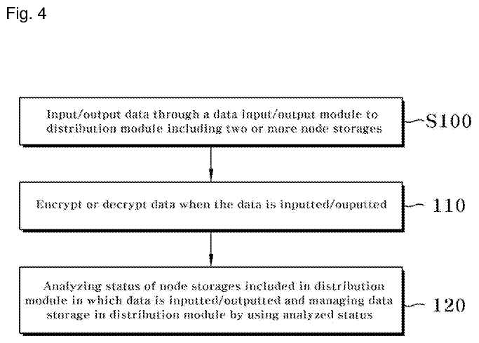

FIG. 1 illustrates a schematic block diagram of a block-chain-based distributed data storage device for storing a large amount of data according to an exemplary embodiment of the present invention, FIG. 2 illustrates a process of storing data in each node storage in the block-chain-based distributed data storage device according to an exemplary embodiment of the present invention, FIG. 3 illustrates a process of controlling data stored in each node storage according to a status of the node storages in the block-chain-based distributed data storage device, and FIG. 4 is a flowchart illustrating a block-chain-based distributed data storage method for storing a large amount of data according to an exemplary embodiment of the present invention.

According to the exemplary embodiment of the present invention, it is possible to provide a data storage device and method, capable of ameliorating a disadvantage that a storage efficiency of a large amount of data is low, which is a drawback of the conventional block-chain technique while maintaining the stability and security of the block-chain technique.

As described above, the block-chain technique is advantageous in that data can be prevented from being corrupted or forged/falsified by modifying and restoring abnormal data through normal data stored in other node storages even when data stored in a node storage is corrupted or forged/falsified. Although the block chain technique has excellent data stability and security as described above, it has a disadvantage in that the efficiency of data storage is very low due to storing the same data in all nodes connected to the network. In addition, according to the exemplary embodiment of the present invention, it is possible to provide a data storage device and method, capable of maximizing the efficiency of data storage even when the large data is stored while maintaining the stability and security of the block-chain technique.

According to the present exemplary embodiment, the block-chain-based distributed data storage device for storing a large amount of data includes: a distribution module 100 configured to include two or more node storages 110 to 160 connected to each other through a network capable of transmitting data to each other such as Internet or Ethernet and each including a storage space in which data can be stored, i.e., a local storage; a data input/output module 200 configured to input and store data in the node storages 110 to 160 serving as local storages of the distribution module 100 and to read data stored in the node storages 110 to 160 therefrom and output it; an encryption/decryption module 300 configured to encrypt or decrypt data when data is inputted into or outputted from the distribution module 100; and a data analysis and management module 400 configured to collect and analyze a status in which data is inputted into or outputted from the distribution module 100 by the data input/output module 200 and to manage an efficiency when data is stored in the distribution module 100.

In addition, when data is inputted into or outputted from distribution module 100 through the data input/output module 200, block data among the data is stored in all node storages by using the block-chain technique or updated when there is variation. The block data includes storage position data related to which node storage stores the data, encryption/decryption data necessary for data encryption/decryption in the encryption/decryption module 300, and authority data for determining whether there is authority to input/output the data.

According to the present exemplary embodiment, the distribution module 100 serves to store data in the data storage device. The distribution module 100 includes two or more node storages 110 to 160 connected with each other through a network capable of transmitting/receiving data such as Internet or Ethernet and a distribution server 600 connected with each of the node storages 110 to 160 through a network. The distribution server 600 is connected with each of the node storages 110 to 160 through a network, and each module necessary for driving the distributed data storage device is installed in the distribution server 600. One or more distribution servers 600 may be provided to perform efficient data input/output depending on the number of the node storages 110 to 160 connected thereto. In addition, when one or more distribution servers 600 are provided, one of the distribution server 600 may be configured to perform a supervisor function for road balancing of each of the distribution servers 600

The node storages 110 to 160 may be exemplified by a PC having a storage device such as an HDD or an SSD capable of storing data. The node storages 110 to 160 may be a personal computer or a server having a large capacity storage device. Since a main function of the is storage and output of data, the node storages 110 to 160 are only required to store data. However, according to the exemplary embodiment of the present invention, input/output of data based on various functions including data input/output, analysis and management of data input/output status, compensation according to contribution levels, etc. must be performed in each of the node storages 110 to 160, and thus it may be desirable to add not only storage but also a device capable of computing.

As described above, the node storages 110 to 160 constituting the distribution module 100 may be configured to be connected with each other through the Internet or Ethernet. Specifically, when they are connected with each other through the Internet, the data input/output is possible in the outside. When they are connected with each other through the Ethernet, access is possible only in the office or home and is difficult in the outside. Accordingly, it may be desirable to use it in a hospital, a company, or the like. Each of the node storages 110 to 160 has its own address regardless of the Internet or Ethernet. As a result, data is inputted/outputted by using an address assigned to each node storage.

When the distributed module 100 is used in a company or a hospital, the node storages 110 to 160 may be provided at the company level or may be configured using company assets. However, it may be desirable to provide personal computers in order to increase the utilization and a degree of freedom of the distribution module 100. When a PC is used, constituent elements necessary for data storage and output including the data input/output module 200, the encryption/decryption module 300, the data analysis and management module 400, and the compensation module 500 may be installed in the distribution server 600 and configured to be operated. Alternatively, in the case of a small number of the node storages, the node storages may be installed in one of the personal computers, which serves as the distribution server 600.

In the present exemplary embodiment, the data input/output module 200 is configured to input and store data into and in the individual node storages 110 to 160 in the distribution module 100 or to read and output the stored data from the node storages 110 to 160. The data input/output module 200 may be configured as hardware to store data in a node storage of a corresponding address or to read and output data when a request is made to store or output data, or may be configured to as software to input/output data by using a computing asset of an individual PC when a request is made to input/output data from the PC. However, in the present exemplary embodiment, when input/output of data is performed through the data input/output module 200, related information is transmitted to the data analysis and management module 400 so that it can be utilized for efficient data input/output management.

In the exemplary embodiment of the present invention, the data input/output module 200 distributes and stores data A to be stored in the node storages 110, 150, and 160 instead of all the node storages 110 to 160. However, block data B including address data of the node storages 110, 150, and 160 in which the data A is stored, encryption data such as an encryption key necessary for encryption/decryption, and authority key data determining authority of data input/output is stored in all the node storages 110 to 160 in the distribution module 100. Since data A is not stored in all the node storages 110 to 160 while maintaining the stability and security of the data, which is an advantage of the block-chain, by storing the data in this manner, efficiency can be maintained even when a large amount of data is stored.

In the present exemplary embodiment, the encryption/decryption module 300 is configured to encrypt or decrypt data stored in each of the node storages 110 to 160 using an encryption key when data is inputted/outputted to the distribution module 100 through the data input/output module 200. In the case that data is stored in individual PCs in a conventional distributed manner and the data is inputted and outputted, an encryption key is often utilized only when determining the authority. Accordingly, when the individual PCs are used for distribution storage, the data stored in the individual PCs are vulnerable because they are defenselessly exposed to the outside. According to the present exemplary embodiment, the data stored in the individual PCs is also encrypted and stored through the encryption/decryption module 300, thereby preventing a security risk caused by data leakage.

In the present exemplary embodiment, the data analysis and management module 400 is configured to collect and analyze data on a data input/output status to efficiently store the data in the distribution module 100.

In the data storage device according to the present exemplary embodiment, the stability and security of data storage is very increased when data is basically distributed and stored in all the node storages 110 to 160. However, when a number of the node storages in which the data is stored is decreased, the efficiency of data storage is increased, but the stability and security of data storage is decreased. It is therefore essential to maintain an adequate number of node storages for data storage. In the present exemplary embodiment, the data analysis and management module 400 first collects information related to the data input/output status related, and then grasps and learns a data input/output pattern using an artificial intelligence algorithm.

Machine learning among artificial intelligence algorithms is largely classified into supervised learning and unsupervised learning. A certain cluster of data can be analyzed and predicted through the supervised learning. Although various kinds of algorithms may be used for unsupervised learning, a k-means algorithm is most easy and efficient. The k-means algorithm is an algorithm that performs clustering using averages of clusters. The total data is divided into clusters that are arbitrarily set, and center values of the respective clusters are arbitrarily set. A distance between an arbitrarily set central value and individual data is measured, and data is allocated to a cluster having a central value closest to the distance. Once the data allocation is completely performed, operations of recalculating the central values for each cluster, remeasuring the distance, and reperforming the data allocation are repeated. Next, when the central value is changed within a predetermined tolerance or the operations are repeated a predetermined number, the operations are stopped to determine clusters. A tendency of data input/output can be grasped through such learning using machine learning, and the efficiency of data storage can be maximized by prioritizing node storages for storing data based on the tendency and storing data. Although the k-means algorithm can perform clustering very simply and efficiently as described above, it is also possible to select a suitable machine learning algorithm according to various requirements such as size, usage, and usage environment of data storage.

In addition, the data analysis and management module 400 manages a number of node storages in which copies of the same data are stored

For example, in the case that the copies are stored in three node storages, when a number of the node storages normally operated among the node storages in which the copies are stored is reduced to less than 3, the number of the node storages normally operated is maintained at 3 or more by replicating the data A to other node storages. By referring to FIG. 3, when some of the node storages 110 are not normally operated, the data A is stored in new node storages 120, and block data B obtained by updating the data related status is distributed and stored in all the node storages. In this way, the stability and security of data storage can be maintained by maintaining the number of normally operating node storages at a predetermined value or higher in any case.

In the present exemplary embodiment, the compensation module 500 is configured to determine a contribution level for data storage, such as data an input/output status and a storage time. As described above, the efficiency and stability of data storage can be improved by grasping the contribution level for the data storage and appropriately compensating owners of the individual node storages. In addition, if the reward is given as crypto currency, there is no need to use an external financial institution, so data input/output and compensation thereof can be performed without external intervention, thereby implementing a spontaneous data storage device can be implemented.

FIG. 4 is a flowchart illustrating a block-chain-based distributed data storage method for storing a large amount of data according to an exemplary embodiment of the present invention. A block-chain-based distributed data storage method for storing a large amount of data according to the exemplary embodiment of the present invention will be described with reference to FIG. 4.

In the block-chain-based distributed data storage method for storing a large amount of data according to the exemplary embodiment of the present invention, data is inputted into and stored in the distribution module 100 including the distribution server 600 and node storages 110 to 160 connected with each other by a network including the Internet and Ethernet, or data stored in the node storages 110 to 160 is read therefrom and is outputted in step S100. In this case, the inputted or outputted data may be a general file, medical information, or other transaction in the transaction of crypto currency. In the present invention, the data may include any data that requires secure and reliable data storage without limitation. When data is inputted or outputted to the node storage in the distribution module 100, the data is encrypted or decrypted through the encryption/decryption module 300 for security in step S110. When the data input/output is performed, a status of each of the node storages 110 to 160 is analyzed, and data storage is managed by collecting the number of the normally operated node storages 110 to 160 every predetermined time for efficient data storage based on the analyzed status in step S120.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of Symbols>

| | |
|---|---|
| data input/output module: 100 | distribution module: 200 |
| encryption/decryption | data analysis and management |
| module: 300 | module: 400 |
| compensation module: 500 | distribution server: 600 |

What is claimed is:

1. A block-chain-based distributed data storage device for storing a large amount of data, the device comprising:
a distribution module configured to include two or more node storages connected with each other through a network including Internet and Ethernet and each including a local storage that is a storage space for data to be stored in the distributed data storage device;
a data input/output module configured to input and store data in the node storages included in the distribution module and to read data stored in the node storages therefrom and output it;
an encryption/decryption module configured to encrypt or decrypt data when the data is inputted into or outputted from the node storages included in the distribution module; and
a module configured to analyze a status of the node storages included in the distribution module inputted or outputted through the data input/output module,
a data analysis and management module configured to analyze a status of the node storages included in the distribution module based on data inputted/outputted through the data input/output module and efficiently managing storage of data in the distribution module by using the analyzed status,
wherein all the node storages included in the distribution module stores and updates block data among data inputted or outputted whenever the data is inputted or outputted through the data input/output module, and the block data includes positions at which the data is stored in the node storages included in the distribution module, encryption/decryption data necessary for data encryption/decryption in the encryption/decryption module, and authority data for determining authority of data input/output.

2. The distributed data storage device of claim 1, wherein the data analysis and management module inputs a copy of same data as data inputted through the data input/output module, into the two or more node storages included in the distribution module.

3. The distributed data storage device of claim 2, wherein the data analysis and management module collects a number of node storages that are normally operated among the node storages in which the copy of the same data is stored every predetermined time.

4. The distributed data storage device of claim 3, wherein the data analysis and management module replicates the copy to another node storage included in the distribution module when the number of normally operating node storage becomes smaller than a predetermined number.

5. The distributed data storage device of claim 3, wherein the data analysis and management module controls a number of the node storages that maintains the copy of the same data after learning information related to normally operating node storages collected at the predetermined time by artificial intelligence, and then learning a pattern of a number of the normally operating node storages.

6. The distributed data storage device of claim 1, wherein the distribution module further includes at least one distribution server connected with each node storage, and the distribution server provides a configuration for driving the block-chain-based distributed data storage device together with the data input/output module, the encryption/decryption module, and the data analysis and management module.

7. The distributed data storage device of claim 1, further comprising
a compensation module configured to calculate a contribution level including a data input/output amount of each node storage and a data storage time, after the data analysis and management module collects a status of data inputted/outputted into/from each node storage in the distribution module.

8. The distributed data storage device of claim 7, wherein the compensation module compensates an owner of each node storage with crypto currency according to the calculated contribution level.

9. A block-chain-based distributed data storage method for storing a large amount of data, the method comprising:
a data input/output operation of inputting/outputting data through a data input/output module which inputs and store data in a distribution module configured to include two or more node storages connected with each other through a network including Internet and Ethernet and each including a local storage and to read data stored in the node storage therefrom and output it;
a data encryption/decryption operation of encrypting or decrypting data through an encryption/decryption module when the data is inputted into or outputted from the node storages included in the distribution module; and
a data analysis and management operation of analyzing a status of the node storages included in the distribution module through the data analysis and management module based on data inputted/outputted through the data input/output module and efficiently managing storage of data in the distribution module by using the analyzed status, wherein the distributed data storage method further comprises storing and updating block data among data inputted or outputted whenever the data is inputted or outputted in the data input/output operation, and the block data includes positions at which the data is stored in the node storages included in the distribution module, encryption/decryption data necessary for encryption/decryption in the encryption/decryption module, and authority data for determining authority of data input/output.

10. The distributed data storage method of claim 9, wherein a copy of same data as data inputted through the data input/output module is inputted into the two or more node storages included in the distribution module, in the data input/output operation.

11. The distributed data storage method of claim 10, further comprising
collecting a number of node storages that are normally operated among the node storages in which the copy of the same data is stored every predetermined time through the data analysis and management module, in the data analysis and management operation.

12. The distributed data storage method of claim 11, further comprising
replicating the copy to another node storage included in the distribution module when the number of normally operating node storage becomes smaller than a predetermined number through the data analysis and management module, in the data analysis and management operation.

13. The distributed data storage method of claim 11, further comprising
controlling a number of the node storages that maintains the copy of the same data after learning information related to normally operating node storages collected at the predetermined time by artificial intelligence, and then learning a pattern of a number of the normally operating node storages through the data analysis and management module, in the data analysis and management operation.

14. The distributed data storage method of claim 9, further comprising
a contribution level calculation operation of calculating a contribution level including a data input/output amount of each node storage and a data storage time through a compensation module based on a status of data inputted/outputted into/from each node storage in the distribution module, collected by the data analysis and management module, in the data analysis and management operation.

15. The distributed data storage method of claim 14, wherein the compensation module compensates an owner of each node storage with crypto currency according to the calculated contribution level, in the contribution level calculation operation.
